(19) United States
(12) Patent Application Publication
(10) Pub. No.: US 2025/0080956 A1
(43) Pub. Date: Mar. 6, 2025

(54) Call Forwarding Enhancements in a Device-to-Device Environment

(71) Applicant: Apple Inc., CUPERTINO, CA (US)

(72) Inventors: Chintan H DALSANIA, Ajax (CA); Pranav TRIPATHI, San Jose, CA (US); Anton BYLIN, Cork (IE)

(21) Appl. No.: 18/817,792

(22) Filed: Aug. 28, 2024

Related U.S. Application Data
(60) Provisional application No. 63/535,926, filed on Aug. 31, 2023.

(51) Int. Cl. H04W 4/16; H04W 4/80

(52) U.S. Cl. CPC H04W 4/16; H04W 4/80

(57) ABSTRACT

An apparatus configured to enable, based on user input, a call forwarding functionality for voice calls, process, based on user input, an identification of a communication device to which voice calls are to be forwarded, generate, for transmission to the communication device via a short-range connection, a forwarding request and process, based on signaling received from the communication device via the short-range connection, a forwarding response indicating whether the communication device has accepted the forwarding request.

### PRIORITY/INCORPORATION BY REFERENCE

This application claims priority to U.S. Provisional Application Ser. No. 63/535,926 filed on Aug. 31, 2023 entitled “Call Forwarding Enhancements in a Device-to-Device Environment,” the entirety of which is incorporated by reference herein.

### BACKGROUND

A first wireless communication device that is capable of performing voice calls may also be capable of forwarding calls to a second wireless communication device. However, there is no manner for the second wireless communication device to know that calls from the first wireless communication device are being forwarded.

### SUMMARY

Some example embodiments are related to an apparatus having processing circuitry configured to enable, based on user input, a call forwarding functionality for voice calls, process, based on user input, an identification of a communication device to which voice calls are to be forwarded, generate, for transmission to the communication device via a short-range connection, a forwarding request and process, based on signaling received from the communication device via the short-range connection, a forwarding response indicating whether the communication device has accepted the forwarding request.

Other example embodiments are related to an apparatus having processing circuitry configured to process, based on signaling received from a communication device via a short-range connection, a forwarding request indicating voice calls destined for the communication device are to be forwarded, configure a user interface (UI) to display the forwarding request, process, based on user input, a response indicating whether a user has accepted the forwarding request and generate, for transmission to the communication device via the short-range connection, a forwarding response indicating whether the forwarding request has been accepted.

Still further example embodiments are related to an apparatus of a communication device configured to operate in dual Subscriber Identity Module (SIM) dual standby (DSDS) mode, the apparatus having processing circuitry configured to connect a voice call using a first connection associated with a first SIM, suspend a second connection associated with a second SIM and configure voice calls to be forwarded from the second SIM to the first SIM while the voice call remains connected using the first connection.

### BRIEF DESCRIPTION OF THE DRAWINGS

FIG. 1 shows an example call forwarding arrangement according to various example embodiments.

FIG. 2 shows an example wireless communication device according to various example embodiments.

FIG. 3 shows an example call flow for a call forwarding between communication devices according to various example embodiments.

FIG. 4 shows an example message format that may be exchanged during a call forwarding process between communication devices according to various example embodiments.

FIG. 5 shows an example method for call forwarding according to various example embodiments.

FIG. 6 shows an example call flow for a call forwarding between communication devices that have a short-range communication connection according to various example embodiments.

FIG. 7 shows an example call flow for a call forwarding between different subscriber identity modules (SIMs) of a same device according to various example embodiments.

FIG. 8 shows an example network arrangement according to various example embodiments.

### DETAILED DESCRIPTION

The example embodiments may be further understood with reference to the following description and the related appended drawings, wherein like elements are provided with the same reference numerals. The example embodiments relate to improved call forwarding behavior for wireless communication devices.

The example embodiments are described with regard to communication devices. As will be described in greater detail below, the communication devices may include any electronic component that may establish a connection to one or more networks and is configured with the hardware, software, and/or firmware to perform voice calls using the one or more networks. In the examples below, the communication devices will be described as wireless communication devices, e.g., communication devices that are capable of establishing connections with a wireless network. However, there is no requirement that the communication devices be wireless communication devices. For example, one of the communication devices described in the example call forwarding arrangements may be a desktop computer hosting a voice call application that has access to a network via a wired connection (e.g., an Ethernet connection). Thus, use of wireless communication devices in the below description is only an example.

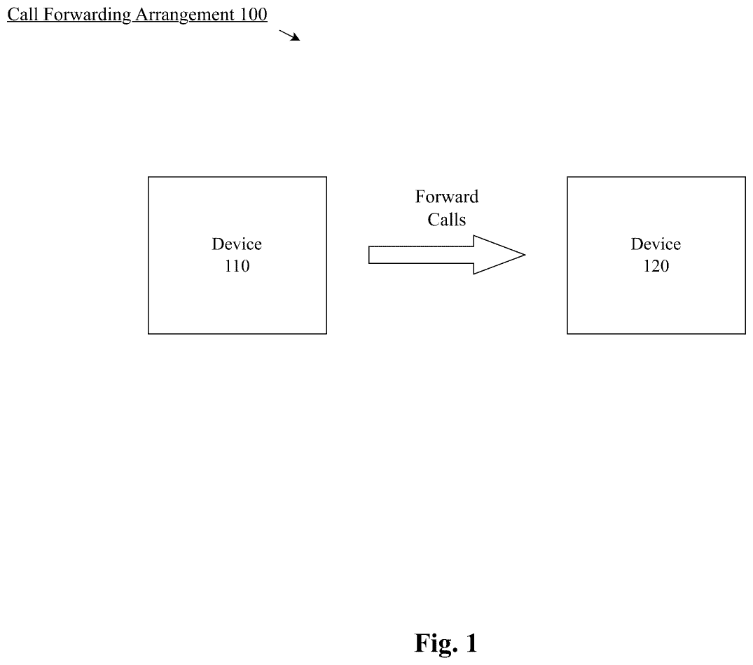

FIG. 1 shows an example call forwarding arrangement 100 according to various example embodiments. The example call forwarding arrangement 100 includes a first wireless communication device 110 and a second wireless communication device 120. Examples of these wireless communication devices 110 and 120 will be described in greater detail below. For the purposes of the example call forwarding arrangement 100, it may be considered that the wireless communication devices 110 and 120 are both capable of performing voice calls.

In the example of FIG. 1, the user of wireless communication device 110 uses the forwarding functionality of a voice application executed by the wireless communication device 110 to forward calls to the wireless communication device 120. As will be described in greater detail below, this forwarding operation may include various intermediary components within the network(s) used to perform the voice calls. However, as described above, when the calls are forwarded to the wireless communication device 120, neither the wireless communication device 120 nor the user of the wireless communication device 120 are aware of the forwarding.

The example embodiments provide manners of notifying the device to which the calls are being forwarded (e.g., the wireless communication device 120) that the calls are being forwarded. In addition, the example embodiments also allow the device to which the calls are being forwarded to accept, reject or conditionally accept the call forwarding from the other device (e.g., the wireless communication device 110). These example embodiments will be described in greater detail below.

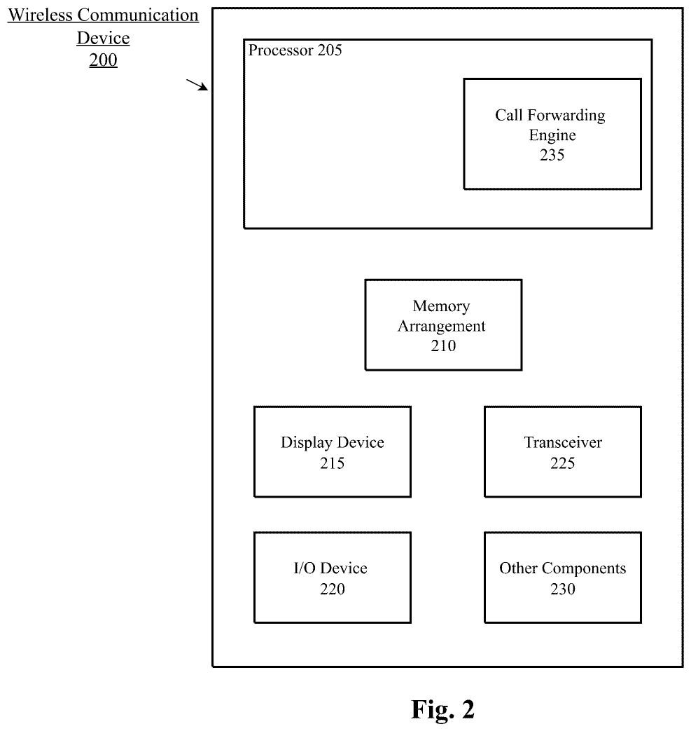

FIG. 2 shows an example wireless communication device 200 according to various example embodiments. The wireless communication device 200 of FIG. 2 may represent the wireless communication device 110 or 120 described with regard to the call forwarding arrangement 100 of FIG. 1. The wireless communication device 200 may be any type of electronic component that is configured to perform voice calls via a network. Non-limiting examples include mobile phones, smartphones, tablet computers, desktop computers, wearables, voice over IP (VOIP) phones, embedded devices, Internet of Things (IoT) devices, etc.

The wireless communication device 200 may include a processor 205, a memory arrangement 210, a display device 215, an input/output (I/O) device 220, a transceiver 225, and other components 230. The other components 230 may include, for example, an audio input device, an audio output device, a data acquisition device, ports to electrically connect the parent 110 to other electronic devices, sensors to detect conditions of the parent 110, etc.

The processor 205 may be configured to execute a plurality of engines for the parent device 110. For example, the engines may include a call forwarding engine 235 for performing operations related to call forwarding between the wireless communication device 200 and another communication device. These operations may include operations performed by the communication device that is forwarding the voice calls and operations performed by the communication device to which the voice calls are being forwarded. Examples of these operations will be described in greater detail below.

The above referenced engine being an application (e.g., a program) executed by the processor 205 is only an example. The functionality associated with the engines may also be represented as a separate incorporated component of the wireless communication device 200 or may be a modular component coupled to the wireless communication device 200, e.g., an integrated circuit with or without firmware. For example, the integrated circuit may include input circuitry to receive signals and processing circuitry to process the signals and other information. The engines may also be embodied as one application or separate applications. In addition, in some parent devices, the functionality described for the processor 205 is split among two or more processors such as a baseband processor and an applications processor. The example embodiments may be implemented in any of these or other configurations of a parent device.

The memory arrangement 210 may be a hardware component configured to store data related to operations performed by the wireless communication device 200. The display device 215 may be a hardware component configured to show data to a user, e.g., display user interfaces (UIs), text messages, etc. The I/O device 220 may be a hardware component that enables the user to enter inputs (e.g., call forwarding instructions, call forwarding acceptances/rejections, etc.). The display device 215 and the I/O device 220 may be separate components or integrated together such as a touchscreen.

The transceiver 225 may be a hardware component configured to establish a connection with one or more networks. For example, the wireless communication device 200 may perform voice calls over cellular networks (e.g., Long Term Evolution (LTE) networks, New Radio (NR) networks, 5G-advanced networks, 6G networks, etc.) or Wi-Fi networks (e.g., IEEE 802.11xx protocol networks). The transceiver 225 may be configured with a network interface card that allows a wired connection to the one or more networks (e.g., Ethernet connection) or may communicate wirelessly with the one or more networks. Accordingly, the transceiver 225 may operate on a variety of different frequencies or channels (e.g., set of consecutive frequencies) to communicate with the networks. The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

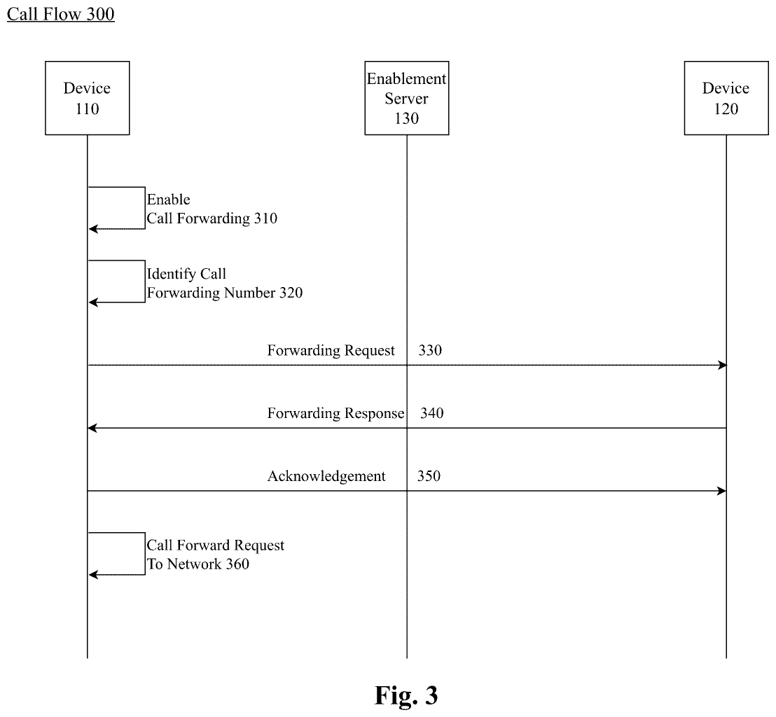

FIG. 3 shows an example call flow 300 for a call forwarding between communication devices 110 and 120 according to various example embodiments. The call flow 300 also includes an enablement server 130. Example operations that may be performed by the enablement server 130 will be described below.

In 310, a user of the wireless communication device 110 may enable call forwarding. For example, a voice call application that is executed by the wireless communication device 110 may include a user interface (UI) that allows the user to select to enable a call forwarding feature of the voice call application.

In 320, the user will identify the communication device to which the voice calls are to be forwarded (e.g., the wireless communication device 120). For example, the UI described above may allow the user to enter the telephone number of the wireless communication device 120.

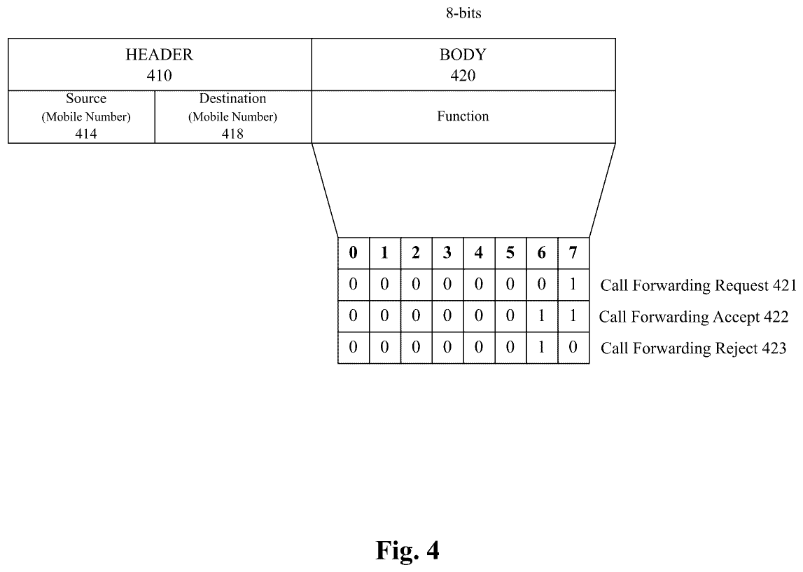

In 330, the wireless communication device 110 may send a forwarding request to the wireless communication device 120. This forwarding request 330 may include various information. In an example, the forwarding request 330 includes, at least, information indicating that the wireless communication device 110 is requesting to forward voice calls to the wireless communication device 120 (e.g., a user of the wireless communication device 110 desires to forward calls to a user of the wireless communication device 120). Examples of other types of information that may be included in the forwarding request 330 are described in greater detail below with reference to FIG. 4.

This forwarding request 330 may be facilitated by the enablement server 130. For example, the wireless communication device 110 and the wireless communication device 120 may be associated with a same equipment manufacturer that implements a messaging service via the enablement server 130 for the wireless communication devices 110 and 120. The messaging service may implement, for example, end to end encryption for messages sent via the messaging service. Thus, the forwarding request 330 may be delivered to the wireless communication device 120 using the enablement server 130. In another example, the forwarding request 330 may be sent via text message (e.g., short message service (SMS)) or multimedia message service (MMS) and the enablement server 130 may be the server that facilitates SMS or MMS messages between the wireless communication devices 110 and 120.

In any case, the wireless communication device 120 may receive the forwarding request 330 and display the forwarding request 330 to a user of the wireless communication device 120. For example, a UI of the wireless communication device 120 may display the message or text message indicating that the wireless communication device 110 is requesting that voice calls be forwarded to the wireless communication device 120.

The user of the wireless communication device 120 may accept, reject or conditionally accept the forwarding request 330. Conditional acceptance will be described in greater detail below. In 340, the wireless communication device 120 will send a forwarding response (e.g., accept, reject or conditionally accept) to the wireless communication device 110. This forwarding response 340 may be sent in the same manner as the forwarding request 330 (e.g., messaging service, text message, etc.).

In 350, the wireless communication device 110 will acknowledge the forwarding response 340 to indicate that the user of the wireless communication device 110 has received the forwarding response 340. If the forwarding response 340 is negative, the call flow 300 may end at this time because the user of the wireless communication device 120 has not accepted the call forwarding request.

If the forwarding response 340 is positive, in 360, the wireless communication device 110 will contact the network (e.g., the cellular network on which the wireless communication device 110 makes/receives voice calls) to indicate voice calls are to be forwarded to the wireless communication device 120. The operation 360 may be the standard operation for the wireless communication device 110 to forward calls to the wireless communication device 120.

If the forwarding response 340 is a conditional acceptance, in 360, the wireless communication device 110 will contact the network to indicate voice calls are to be forwarded to the wireless communication device 120 but there may be further information that is entered by the user prior to the operation 360. Examples of this further information will be described in greater detail below.

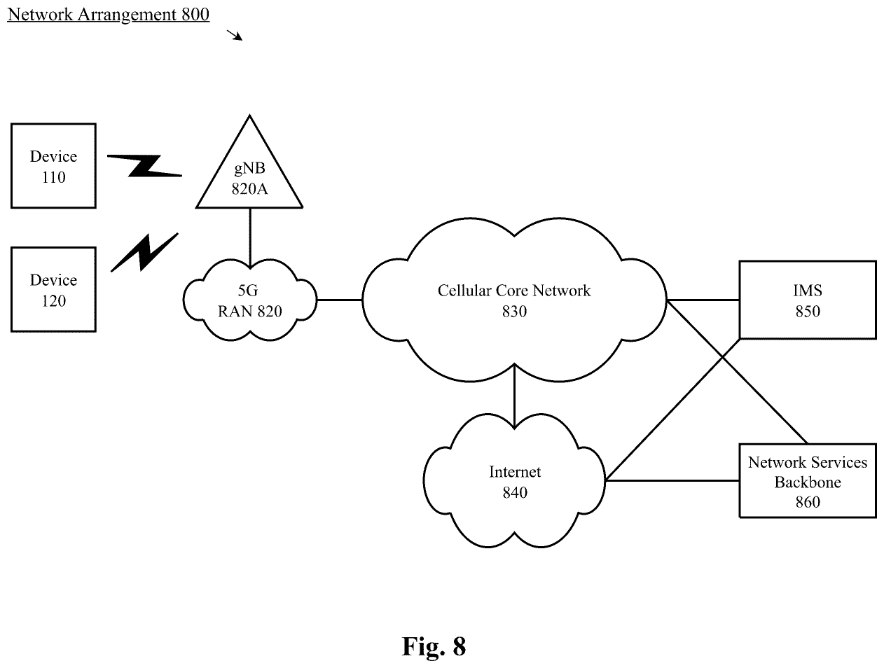

FIG. 8 shows an example network arrangement 800 according to various example embodiments. The example network arrangement 800 includes the wireless communications devices 110 and 120, which were described above. An actual network arrangement may include any number of wireless communication devices being used by any number of users. Thus, the example of the two wireless communications devices 110 and 120 is merely provided for illustrative purposes.

The wireless communications devices 110 and 120 may be configured to communicate with one or more networks. In the example of the network configuration 800, the network with which the wireless communications devices 110 and 120 may wirelessly communicate is a 5G NR radio access network (RAN) 820. However, the wireless communications devices 110 and 120 may also communicate with other types of networks (e.g., sixth generation (6G) RAN, 5G cloud RAN, a next generate RAN (NG-RAN), a legacy cellular network, a wireless local area network (WLAN), etc.) and the wireless communications devices 110 and 120 may also communicate with networks over a wired connection. Therefore, the wireless communications devices 110 and 120 may have a 5G NR chipset to communicate with the NR RAN 820 and, optionally, any other appropriate type of chipset to communicate with other types of networks.

The 5G NR RAN 820 may be a portion of a cellular network that may be deployed by a network carrier (e.g., Verizon, AT&T, Sprint, T-Mobile, etc.). The 5G NR RAN 820 may include cells and base stations that are configured to send and receive traffic from wireless communications devices that are equipped with the appropriate cellular chip set. In this example, the 5G NR RAN 120 includes the gNB 820A. However, reference to a gNB is merely provided for illustrative purposes, the example embodiments may be utilized with any appropriate type of access node (e.g., Node Bs, eNodeBs, HeNBs, eNBs, gNBs, gNodeBs, macrocells, microcells, small cells, femtocells, etc.).

Any association procedure may be performed for the wireless communications devices 110 and 120 to connect to the 5G NR RAN 180. For example, as discussed above, the 5G NR RAN 820 may be associated with a particular network carrier where the wireless communications devices 110 and 120 and/or the users thereof have a contract and credential information (e.g., stored on a SIM card). Upon detecting the presence of the 5G NR RAN 820, the wireless communications devices 110 and 120 may transmit the corresponding credential information to associate with the 5G NR RAN 820. More specifically, the wireless communications devices 110 and 120 may associate with a specific cell (e.g., the gNB 820A). The wireless communications devices 110 and 120 associating with the same gNB 820A is only an example, e.g., the wireless communications devices 110 and 120 may associate with different base stations of the 5G NR RAN 820.

The network arrangement 800 also includes a cellular core network 830, the Internet 840, an IP Multimedia Subsystem (IMS) 850, and a network services backbone 860. The cellular core network 830 may refer to an interconnected set of components that manages the operation and traffic of the cellular network. The cellular core network 830 also manages the traffic that flows between the cellular network and the Internet 840. The IMS 850 may be generally described as an architecture for delivering multimedia services to the wireless communications devices 110 and 120 using the IP protocol. The IMS 850 may communicate with the cellular core network 830 and the Internet 840 to provide the multimedia services to the wireless communications devices 110 and 120. The network services backbone 860 is in communication either directly or indirectly with the Internet 840 and the cellular core network 830. The network services backbone 860 may be generally described as a set of components (e.g., servers, network storage arrangements, etc.) that implement a suite of services that may be used to extend the functionalities of the wireless communications devices 110 and 120 in communication with the various networks. In one example, the enablement server 130 is a component of the network services backbone 860. However, this is only an example and the enablement server 130 may be resident anywhere within the network arrangement 800.

FIG. 4 shows an example message format 400 that may be exchanged during a call forwarding process between communication devices according to various example embodiments. The message format 400 may be used for the forwarding request 330 and/or the forwarding response 340 and as described above may be delivered via, for example, a messaging service, text message, etc.

The example message format 400 may comprise a header 410 and a body 420. The header 410 may include a first field 414 that provides an identification of the source device that is requesting the call forwarding (e.g., the wireless communication device 110). The identification may be, for example, the phone number of the source device. However, other manners of identifying the source device may also be used. The header 410 may also include a second field 418 that provides an identification of the destination device to which the voice calls are to be forwarded (e.g., the wireless communication device 120). Again, the identification may be, for example, the phone number of the destination device or any other manner of identifying the destination device.

The body 420 may comprise an 8-bit field that may be used to convey information concerning the call forwarding operation. For example, if the message format 400 is used for the forwarding request 330, the body 420 may be set to the bitmap 421. To provide an example, the wireless communication device 110 may format a forwarding request 330 comprising an identification of the wireless communication device 110 as the source device, an identification of the wireless communication device 120 as the destination device and a body with the bitmap 421. When the wireless communication device 120 receives the forwarding request 330 in this format, the wireless communication device 120 will understand that from the bitmap 421 in the body 420 that the wireless communication device 110 desires to forward voice calls to the wireless communication device 120.

The wireless communication device 120 may also use the message format 400 for the forwarding response 340. The source field 414 and the destination field 418 may be the same as described above. If the forwarding response 340 is positive, the bitmap 422 may be included as the body 420 of the forwarding response 340. If the forwarding response 340 is negative, the bitmap 423 may be included as the body 420 of the forwarding response 340.

In this example of an 8-bit body 420, five (5) unused bitmaps remain. These bitmaps may be used for other purposes, including being related to conditional acceptances. The use of an 8-bit body 420 is only an example, as bodies of larger or smaller than 8-bits may also be used. In addition, the bitmaps 421-423 are only examples as other bitmaps may be used to signal the information described for these bitmaps.

As described above, the forwarding request 330 may include the information that the wireless communication device 110 desires to forward voice calls to the wireless communication device 120. Other information may also be included in the forwarding request 330. For example, the user of the wireless communication device 110 may also be presented with additional options related to the call forwarding, for example, via the UI of the wireless communication device 110. These additional options may allow the user to select parameters related to the call forwarding such as a duration, a start time, an end time, etc.

In some example embodiments, this additional information may be signaled via one or more of the remaining bitmaps of the example 8-bit body 420 of the message format 400. For example, a first one of the remaining bitmaps of the example 8-bit body 420 may correspond to a request for call forwarding for a duration of 1 hour, a second one of the remaining bitmaps may correspond to a request for call forwarding for a duration of 2 hours, a third one of the remaining bitmaps may correspond to a request to start call forwarding at the beginning of the next hour, etc.

In other example embodiments, the bitmap of the example 8-bit body 420 may be used to signal that a further message regarding the call forwarding request is going to be sent by the wireless communication device 110. For example, one of the bitmaps may correspond to an indication of a call forwarding request and a further message indicating a duration of the call forwarding request. This further message including the duration information may be sent at a later time, e.g., after the forwarding request 330 but before the forwarding response 340. When the wireless communication device 120 receives this information in the forwarding request 330, the wireless communication device 120 will understand to wait for the follow up message prior to sending the forwarding response 340.

Also, as described above, when the wireless communication device 120 sends the forwarding response 340, this may include a conditional acceptance. A conditional acceptance may include an indication from the wireless communication device 120 of a period of accepted call forwarding that is different than the period of call forwarding proposed by the request from wireless communication device 110. The conditional acceptance may be a period that has a different start time, a different end time, or both. The conditional acceptance may be a period that is shorter than the proposed period, or a period that is longer than the proposed period. To provide an example, the wireless communication device 110 may have requested a call forwarding duration of 2 hours. The wireless communication device 120 may indicate in the forwarding response 340 that the call forwarding is conditionally accepted but only for a duration of 1 hour. In another example, the wireless communication device 110 may have requested a call forwarding start time of 1:00 pm and an end time of 3:00 pm. The wireless communication device 120 may indicate in the forwarding response 340 that the call forwarding is conditionally accepted with a start time of 2:00 pm and an end time of 4:00 pm.

Again, this conditional acceptance may be signaled via one or more of the remaining bitmaps of the body 420 of the message format 400 or may be signaled using another message format. For example, a first one of the remaining bitmaps of the example 8-bit body 420 may correspond to conditional acceptance but different duration, a second one of the remaining bitmaps may correspond to conditional acceptance but different start time, a third one of the remaining bitmaps may correspond to conditional acceptance but different end time, a fourth one of the remaining bitmaps may correspond to conditional acceptance but different start and end times, etc.

In some example embodiments, the details of the conditional acceptance may be included in the forwarding response 340 (e.g., the accepted duration, the accepted start time, the accepted end time, etc.). In other example embodiments, the bitmap of the example 8-bit body 420 may be used to signal that a further message regarding the conditional acceptance is going to be sent by the wireless communication device 120, e.g., the details of the conditional acceptance.

In some embodiments, the conditional acceptance may provide enough information for the user of the wireless communication device 110 to continue with the conditions put on the acceptance by the wireless communication device 120, e.g., after receiving the conditional acceptance the wireless communication device 110 may send the acknowledgement 350 and send the call forwarding request to the network 360.

In other embodiments, the conditional acceptance may trigger further negotiations between the wireless communication devices 110 and 120. For example, when the wireless communication device 110 receives the conditional acceptance in the forwarding response 340, this may trigger the wireless communication device 110 to send additional messages to the wireless communication device 120 to determine details regarding the conditional acceptance and/or determine if the user of the wireless communication device 120 will accept different conditions. These exchanges may be similar to the exchanges already described above (e.g., the forwarding request 340, the forwarding response 350, etc.)

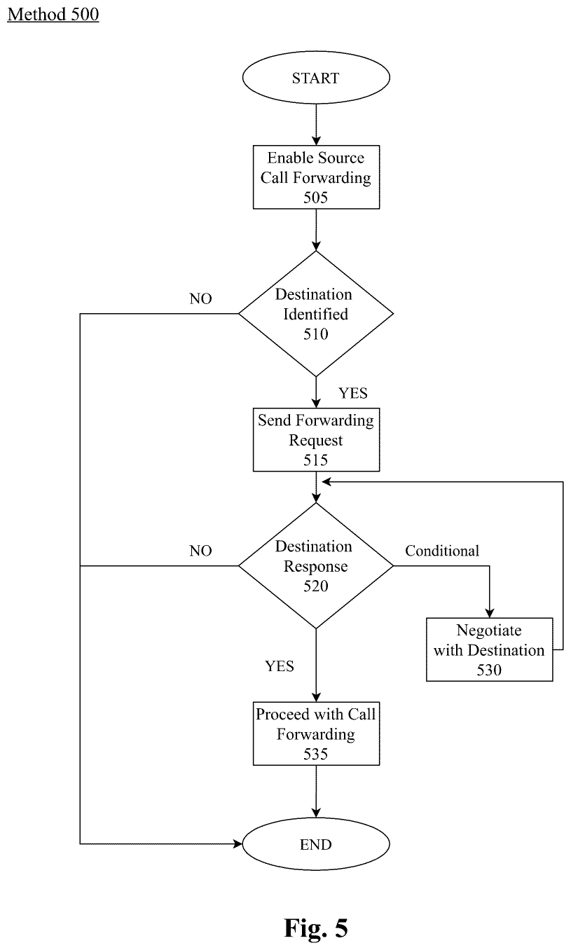

FIG. 5 shows an example method 500 for call forwarding according to various example embodiments. The method 500 is described from the point of view of the source device (e.g., the wireless communication device 110).

In 505, the user (or the voice call application) of the source device enables call forwarding. In 510, the source device determines whether the user has identified a destination for the call forwarding. In the example of FIG. 5, the user may not have entered a destination phone number and the method 500 ends. However, if the call forwarding remains enabled, this may be a continuous determination until call forwarding is disabled or the user enters the destination phone number.

Once the destination phone number has been received by the source device, in 515, the source device sends the forwarding request (e.g., the forwarding request 330) to the destination device. In 520, the source device receives the forwarding response (e.g., the forwarding response 340) from the destination device.

If the response is negative, the method 500 ends and no call forwarding is implemented. If the response is positive, the method continues to 535 where the source proceeds with the call forwarding operation by contacting the network and indicating voice calls for the source device may be forwarded to the destination device.

If the response is a conditional acceptance, the method may continue to 535 where the source proceeds with the call forwarding operation by contacting the network and indicating voice calls for the source device may be forwarded to the destination device. This is not shown in FIG. 5. Rather FIG. 5 shows that upon receiving conditional acceptance, the source device, in 530, continues negotiations with the destination device to determine the details of the conditional acceptance. Once these details are acceptable to both the source and destination devices, the source device may receive a positive response to the forwarding request and the method may continue to 535 where the source proceeds with the call forwarding operation by contacting the network.

To provide an example of the conditional acceptance and negotiations. In 515, the source device may send the forwarding request that includes a requested time duration and start time, e.g., 2:00 hours starting at 1:00 pm. The destination device may send a conditional acceptance with a negotiated time, e.g., 1:00 hour starting at 1:00 pm. The source device may accept this conditional acceptance and proceed with the call forwarding as negotiated by the destination device by sending an acknowledgement or the source device may find an alternative. For example, the user of the source device (via the voice call application) may decide to send the forwarding request to a different destination device. In another example, the user of the source device (via the voice call application) may decide to send an updated forwarding request with a different time duration and/or start time, e.g., 1:30 hours at 1:00 pm, 2:00 hours at 3:00 pm, etc.

In the above examples, it was considered that the source and destination devices communicated regarding the call forwarding via a messaging service, e.g., the source and destination devices were remote from each other. In the following example embodiments, it may be considered that the source and destination devices are in close proximity to each other and may communicate via a short-range connection. The short-range connection may be, for example, a cellular sidelink connection, a Bluetooth connection, a Zigbee connection, a Wi-Fi Direct connection, etc. As will be described in the examples below, a short range connection may alleviate the need for the intervening enablement server (e.g., the enablement server 130 described with reference to FIG. 3). Devices in close proximity to each other may have no need for the enablement server as the devices may communicate directly to one another over the short-range connection.

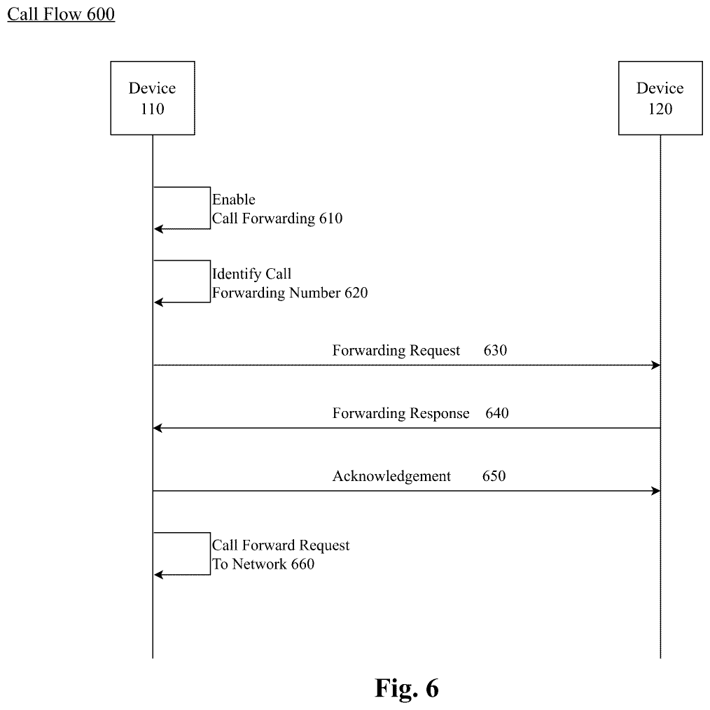

FIG. 6 shows an example call flow 600 for a call forwarding between communication devices 110 and 120 that have a short-range communication connection according to various example embodiments. The call flow 600 is similar to the call flow 300, except, as described above, there is no need for the enablement server 130 to facilitate the sending of messages between the wireless communication devices 110 and 120.

In some examples of the call flow 600, the wireless communication devices 110 and 120 may already have an active short-range communication link before the operations of the call flow 600 commence. In other examples of the call flow 600, the operations of the call flow 600 may trigger the wireless communication devices 110 and 120 to establish an active short-range communication link.

In 610, a user of the wireless communication device 110 may enable call forwarding. In 620, the user identifies the communication device to which the voice calls are to be forwarded (e.g., the wireless communication device 120).

In the examples where there is no active short-range communication link between the wireless communication devices 110 and 120, the user input into the wireless communication device 110 may cause the wireless communication device 110 to establish a short-range communication link to the wireless communication device 120.

In 630, the wireless communication device 110 may send a forwarding request to the wireless communication device 120 via the short-range communication link. The forwarding request 630 may be similar to the forwarding request 330 described above.

The wireless communication device 120 may receive the forwarding request 630 and display the forwarding request 630 to a user of the wireless communication device indicating that the wireless communication device 110 is requesting that voice calls be forwarded to the wireless communication device 120.

The user of the wireless communication device 120 may accept, reject or conditionally accept the forwarding request 630. In 640, the wireless communication device 120 will send a forwarding response (e.g., accept, reject or conditionally accept) to the wireless communication device 110 via the short-range communication link. The forwarding response 640 may be similar to the forwarding response 340 described above.

In 650, the wireless communication device 110 will acknowledge the forwarding response 640 via the short-range communication link to indicate that the user of the wireless communication device 110 has received the forwarding response 640. If the forwarding response 640 is negative, the call flow 600 may end at this time because the user of the wireless communication device 120 has not accepted the call forwarding request.

If the forwarding response 640 is positive, in 660, the wireless communication device 110 may contact the network (e.g., the cellular network on which the wireless communication device 110 makes/receives voice calls) to indicate voice calls are to be forwarded to the wireless communication device 120. The operation 660 may be the standard operation for the wireless communication device 110 to forward calls to the wireless communication device 120.

If the forwarding response 640 is a conditional acceptance, the operations may be similar to the operations described above for conditional acceptance.

In all the above examples, there are scenarios where the wireless communication device 110 has forwarded voice calls to the wireless communication device 120. In current scenarios where calls are forwarded, there is no mechanism for a user of the device to which the calls are forwarded (e.g., the wireless communication device 120) to know if a received voice call was originally destined for the wireless communication device 120 or is a call that is forwarded (e.g., the voice call was originally destined for the wireless communication device 110).

The example embodiments provide a manner for the user of the wireless communication device 120 to understand whether a received call is a forwarded call. For example, when the wireless communication device 120 receives a voice call, the wireless communication device 120 may inspect the data associated with the voice call. This data may include information that is included in a session initiation protocol (SIP) message associated with the voice call. This data may indicate that the voice call is a forwarded call, e.g., an identification of the wireless communication device 110 is included in a field of the SIP message. When the wireless communication device 120 determines that the voice call is a forwarded call, a UI of the wireless communication device 120 may indicate that the call is a forwarded call and the communication device from which the call is forwarded (e.g., the wireless communication device 110). In this way, the user of the wireless communication device 120 is aware that the voice call was not originally destined for the wireless communication device 120 and may act appropriately in response to this information, e.g., handing the wireless communication device 120 to the user of the wireless communication device 110 so that they may answer the voice call.

In the above examples, it was considered that the source and destination devices were different physical device. In the following example embodiments, it may be considered that the source and destination devices are different subscriber identity modules (SIMs) in the same device. Thus, these examples consider the scenario of a wireless communication device that includes two SIMs that are both active (e.g., the communication device may operate in dual SIM dual standby (DSDS) mode.

Under normal circumstances, in the DSDS scenario, when a voice call is received on a connection associated with one of the SIMS, the other SIM is suspended, e.g., the connection associated with the other SIM is out of service (OOS). In this scenario, the user of the communication device cannot receive a call on the connection associated with the other SIM. This may cause a negative user experience because the other SIM may receive an important call (e.g., from a child's school, from a hospital, etc.) that the user cannot accept because the other SIM is OOS. The following example embodiments address this issue and allow calls to be forwarded from a suspended SIM to a currently active SIM.

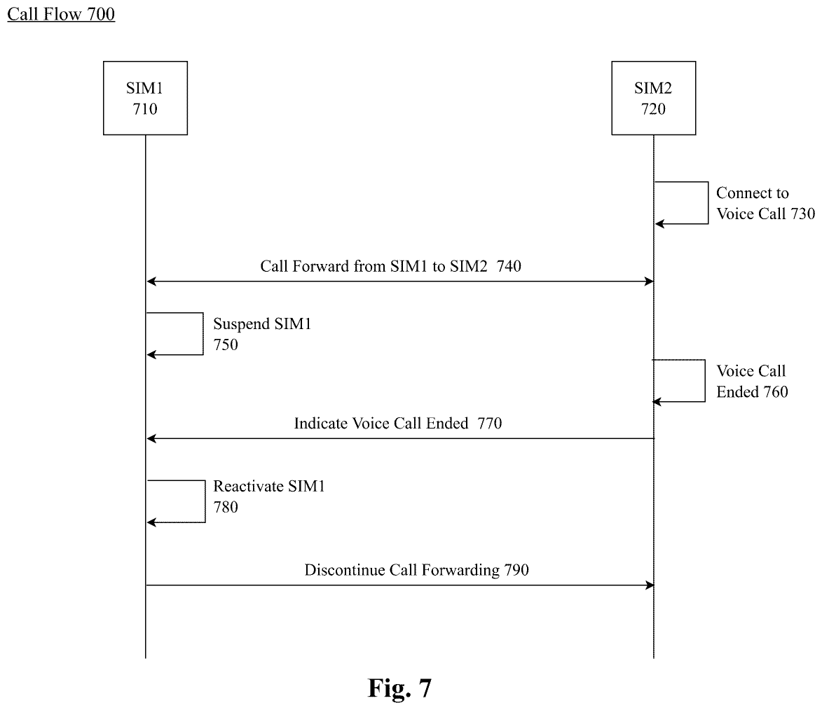

FIG. 7 shows an example call flow 700 for a call forwarding between different subscriber identity modules (SIMs) of a same device according to various example embodiments. The call flow 700 is shown as occurring between a SIM1 710 and a SIM2 720. As described above, the SIM1 710 and a SIM2 720 are SIMs of a same communication device that is operating in DSDS mode. Thus, prior to the start of the call flow 700, both the SIM1 710 and a SIM2 720 may have an active communication link with their respective network.

In 730, a user of the communication device makes or accepts a voice call using the connection associated with the. SIM2 720. In 740, an indication is provided to the SIM1 710 that there is an active voice call using the SIM2 720. The SIM1 710 may forward voice calls to the SIM2 720 while the voice call is active on the SIM2 720. In some examples, this may be automatic as soon as one of the SIMS is engaged in an active voice call. In other examples, the communication device may display, via a UI, an option for a user of the communication device to forward voice calls from the SIM that is not engaging in the active voice call. In the call flow 700, it is assumed that the calls are forwarded from the SIM1 710 to the SIM 2 720.

In 750, the SIM1 710 is suspended because the SIM2 720 is on an active voice call. However, because call forwarding has been set up, the user may receive a voice call destined for the SIM1 710 on the connection associated with the SIM2 720 during the time that the voice call is active on the SIM2 720.

In 760, the active voice call on the SIM2 720 is terminated. In. 770, the SIM2 720 informs the SIM1 710 that the voice call has been terminated allowing the SIM1 710 to be reactivated in 780. In 790, the call forwarding from SIM1 710 to SIM2 720 is discontinued because the communication device is again capable of receiving voice calls on connections associated with either the SIM1 710 or the SIM2 720.

### EXAMPLES

In a first example, a method, comprising enabling, based on user input, a call forwarding functionality for voice calls, processing, based on user input, an identification of a communication device to which voice calls are to be forwarded, generating, for transmission to the communication device via a short-range connection, a forwarding request, and processing, based on signaling received from the communication device via the short-range connection, a forwarding response indicating whether the communication device has accepted the forwarding request.

In a second example, the method of the first example, wherein the short-range connection comprises a cellular sidelink connection, a Bluetooth connection, a Zigbee connection or a Wi-Fi Direct connection.

In a third example, the method of the first example, further comprising generating, for transmission to the communication device via the short-range connection, an acknowledgement corresponding to the forwarding response.

In a fourth example, the method of the first example, further comprising determining the forwarding response indicates the communication device has accepted the forwarding request; and, in response to the determination that the second communication device has accepted the forwarding request, generating, for transmission to a network, a request to forward calls to the communication device.

In a fifth example, the method of the first example, further comprising determining the forwarding response indicates the communication device has not accepted the forwarding request and, in response to the determination that the communication device has not accepted the forwarding request, disabling the call forwarding functionality.

In a sixth example, the method of the first example, further comprising determining the forwarding response indicates the communication device has conditionally accepted the forwarding request.

In a seventh example, the method of the sixth example, further comprising, in response to the determination that the communication device has conditionally accepted the forwarding request, generating, for transmission to a network, a request to forward calls to the communication device.

In an eighth example, the method of the sixth example, further comprising, generating, for transmission to the communication device, a further forwarding request comprising information related to the conditionally accepted forwarding request.

In a ninth example, the method of the first example, wherein the identification comprises a phone number of the communication device.

In a tenth example, the method of the first example, wherein the forwarding request comprises (i) a header identifying the communication device and (ii) a body comprising a bitmap indicating the forwarding request to forward voice calls to the communication device.

In an eleventh example, the method of the first example, wherein the forwarding response comprises (i) a header identifying the communication device and (ii) a body comprising a bitmap indicating the communication device accepted the forwarding request, did not accept the forwarding request or conditionally accepted the forwarding request.

In a twelfth example, the method of the first example, wherein the forwarding request comprises information related to forwarding of the voice calls.

In a thirteenth example, the method of the twelfth example, wherein the information comprises a duration of the call forwarding, a start time of the call forwarding or an end time of the call forwarding.

In a fourteenth example, a processor configured to perform any of the methods of the first through thirteenth examples.

In a fifteenth example, a wireless communication device configured to perform any of the methods of the first through thirteenth examples.

In a sixteenth example, a method, comprising processing, based on signaling received from a communication device via a short-range connection, a forwarding request indicating voice calls destined for the communication device are to be forwarded, configuring a user interface (UI) to display the forwarding request, processing, based on user input, a response indicating whether a user has accepted the forwarding request and generating, for transmission to the communication device via the short-range connection, a forwarding response indicating whether the forwarding request has been accepted.

In a seventeenth example, the method of the sixteenth example, wherein the short-range connection comprises a cellular sidelink connection, a Bluetooth connection, a Zigbee connection or a Wi-Fi Direct connection.

In an eighteenth example, the method of the sixteenth example, further comprising processing, based on signaling received from the communication device, an acknowledgement corresponding to the forwarding response.

In a nineteenth example, the method of the sixteenth example, wherein the forwarding request comprises (i) a header identifying the communication device and (ii) a body comprising a bitmap indicating the communication device is requesting to forward voice calls to the first communication device.

In a twentieth example, the method of the sixteenth example, wherein the forwarding response comprises (i) a header identifying the communication device and (ii) a body comprising a bitmap indicating the forwarding request has been accepted, not accepted or conditionally accepted.

In a twenty first example, the method of the twentieth example, further comprising processing, based on signaling received from the communication device, a further forwarding request comprising information related to the conditionally accepted forwarding request.

In a twenty second example, the method of the sixteenth example, wherein the forwarding request comprises information related to forwarding of the voice calls.

In a twenty third example, the method of the twenty second example, wherein the information comprises a duration of the call forwarding, a start time of the call forwarding or an end time of the call forwarding.

In a twenty fourth example, a processor configured to perform any of the methods of the sixteenth through twenty third examples.

In a twenty fifth example, a wireless communication device configured to perform any of the methods of the sixteenth through twenty third examples.

In a twenty sixth example, a method performed by an apparatus of a communication device configured to operate in dual Subscriber Identity Module (SIM) dual standby (DSDS) mode, the method, comprising connecting a voice call using a first connection associated with a first SIM, suspending a second connection associated with a second SIM and configuring voice calls to be forwarded from the second SIM to the first SIM while the voice call remains connected using the first connection.

In a twenty seventh example, the method of the twenty sixth example, further comprising configuring a user interface (UI) of the communication device to display an option for a user to select voice calls to be forwarded from the second SIM to the first SIM while the voice call remains connected using the first connection.

In a twenty eighth example, the method of the twenty sixth example, further comprising determining the voice call has been disconnected, disabling voice calls being forwarded from the second SIM to the first SIM in response to the voice call being disconnected and reactivating the second connection associated with the second SIM in response to the voice call being disconnected.

In a twenty ninth example, a processor configured to perform any of the methods of the twenty sixth through twenty eighth examples.

In a thirtieth example, a wireless communication device configured to perform any of the methods of the twenty sixth through twenty eighth examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry configured to:
enable, based on user input, a call forwarding functionality for voice calls;
process, based on user input, an identification of a communication device to which voice calls are to be forwarded;
generate, for transmission to the communication device via a short-range connection, a forwarding request; and
process, based on signaling received from the communication device via the short-range connection, a forwarding response indicating whether the communication device has accepted the forwarding request.

2. The apparatus of claim 1, wherein the short-range connection comprises a cellular sidelink connection, a Bluetooth connection, a Zigbee connection or a Wi-Fi Direct connection.

3. The apparatus of claim 1, wherein the processing circuitry is further configured to:
generate, for transmission to the communication device via the short-range connection, an acknowledgement corresponding to the forwarding response.

4. The apparatus of claim 1, wherein the processing circuitry is further configured to:
determine the forwarding response indicates the communication device has accepted the forwarding request; and
in response to the determination that the second communication device has accepted the forwarding request, generate, for transmission to a network, a request to forward calls to the communication device.

5. The apparatus of claim 1, wherein the processing circuitry is further configured to:
determine the forwarding response indicates the communication device has not accepted the forwarding request; and
in response to the determination that the communication device has not accepted the forwarding request, disable the call forwarding functionality.

6. The apparatus of claim 1, wherein the processing circuitry is further configured to:
determine the forwarding response indicates the communication device has conditionally accepted the forwarding request.

7. The apparatus of claim 6, wherein the processing circuitry is further configured to:
in response to the determination that the communication device has conditionally accepted the forwarding request, generate, for transmission to a network, a request to forward calls to the communication device.

8. The apparatus of claim 6, wherein the processing circuitry is further configured to:
generate, for transmission to the communication device, a further forwarding request comprising information related to the conditionally accepted forwarding request.

9. The apparatus of claim 1, wherein the identification comprises a phone number of the communication device.

10. The apparatus of claim 1, wherein the forwarding request comprises (i) a header identifying the communication device and (ii) a body comprising a bitmap indicating the forwarding request to forward voice calls to the communication device.

11. The apparatus of claim 1, wherein the forwarding response comprises (i) a header identifying the communication device and (ii) a body comprising a bitmap indicating the communication device accepted the forwarding request, did not accept the forwarding request or conditionally accepted the forwarding request.

12. An apparatus comprising processing circuitry configured to:
process, based on signaling received from a communication device via a short-range connection, a forwarding request indicating voice calls destined for the communication device are to be forwarded;
configure a user interface (UI) to display the forwarding request;
process, based on user input, a response indicating whether a user has accepted the forwarding request; and
generate, for transmission to the communication device via the short-range connection, a forwarding response indicating whether the forwarding request has been accepted.

13. The apparatus of claim 12, wherein the short-range connection comprises a cellular sidelink connection, a Bluetooth connection, a Zigbee connection or a Wi-Fi Direct connection.

14. The apparatus of claim 12, wherein the processing circuitry is further configured to:
process, based on signaling received from the communication device, an acknowledgement corresponding to the forwarding response.

15. The apparatus of claim 12, wherein the forwarding request comprises (i) a header identifying the communication device and (ii) a body comprising a bitmap indicating the communication device is requesting to forward voice calls to the first communication device.

16. The apparatus of claim 12, wherein the forwarding response comprises (i) a header identifying the communication device and (ii) a body comprising a bitmap indicating the forwarding request has been accepted, not accepted or conditionally accepted.

17. The apparatus of claim 16, wherein the processing circuitry is further configured to:
process, based on signaling received from the communication device, a further forwarding request comprising information related to the conditionally accepted forwarding request.

18. An apparatus of a communication device configured to operate in dual Subscriber Identity Module (SIM) dual standby (DSDS) mode, the apparatus comprising processing circuitry configured to:
connect a voice call using a first connection associated with a first SIM;
suspend a second connection associated with a second SIM; and
configure voice calls to be forwarded from the second SIM to the first SIM while the voice call remains connected using the first connection.

19. The apparatus of claim 18, wherein the processing circuitry is further configured to:
configure a user interface (UI) of the communication device to display an option for a user to select voice calls to be forwarded from the second SIM to the first SIM while the voice call remains connected using the first connection.

20. The apparatus of claim 18, wherein the processing circuitry is further configured to:
determine the voice call has been disconnected;
disable voice calls being forwarded from the second SIM to the first SIM in response to the voice call being disconnected; and
reactivate the second connection associated with the second SIM in response to the voice call being disconnected.
